(19) United States
(12) Patent Application Publication
(10) Pub. No.: US 2023/0407920 A1
(43) Pub. Date: Dec. 21, 2023

(54) ROLLING BEARING ASSEMBLY CAPABLE OF REALIZING SELF-MONITORING

(71) Applicant: Schaeffler Technologies AG & Co. KG, Herzogenaurach (DE)

(72) Inventors: Suxia Wang, Taicang (CN); Ran Guan, Shanghai (CN); Xiangrui Xia, Shanghai (CN); Jingfeng Xu, Shanghai (CN)

(73) Assignee: Schaeffler Technologies AG & Co. KG, Herzogenaurach (DE)

(21) Appl. No.: 18/035,597

(22) PCT Filed: Nov. 24, 2020
(86) PCT No.: PCT/CN2020/131185

§ 371 Date: May 5, 2023

(51) Int. Cl. F16C 33/58; F16C 41/00

(52) U.S. Cl. CPC F16C 33/583; F16C 41/00; F16C 2233/00

(57) ABSTRACT

A rolling bearing assembly, capable of realizing self-monitoring, includes a rolling bearing having a ring and a wireless sensor. The ring is provided with an assembly groove, and the wireless sensor is mounted in the assembly groove. The assembly groove is located in a circumferential face of the ring and has an opening that is open in the axial direction of the rolling bearing and/or the assembly groove is located in an axial end face of the ring and has an opening that is open in the radial direction of the rolling bearing.

### CROSS-REFERENCE TO RELATED APPLICATIONS

This application is the U.S. National Phase of PCT Appln. No. PCT/CN2020/131185 filed Nov. 24, 2020, the entire disclosure of which is incorporated by reference herein.

### TECHNICAL FIELD

The present disclosure relates to bearings, and in particular to a rolling bearing assembly capable of realizing self-monitoring.

### BACKGROUND

At present, there is a need to monitor a rolling bearing in operation, for example, monitoring the temperature property, vibration property and the like of a fixed ring of the rolling bearing, and the fixed ring can be monitored online by an external sensor.

As for how to monitor a rotating ring, some prior arts provide solutions by arranging wireless sensors. However, the mounting of the wireless sensors is complicated, leading to a complicated bearing structure, which increases the difficulty in machining the bearing.

### SUMMARY

The purpose of the present disclosure is to overcome or at least alleviate the above-mentioned deficiencies of the prior arts, and to provide a rolling bearing assembly capable of realizing self-monitoring. A rotating ring of the rolling bearing may be monitored in real time by a wireless sensor, and the rolling bearing has a simple structure.

A rolling bearing assembly, according to an exemplary embodiment, is provided that is capable of realizing self-monitoring. The rolling bearing assembly includes a rolling bearing having a ring and a wireless sensor; and the ring is provided with an assembly groove. The wireless sensor is mounted in the assembly groove. The assembly groove is located in a circumferential face of the ring and has an opening that is open in an axial direction of the rolling bearing, and/or the assembly groove is located in an axial end face of the ring and has an opening that is open in a radial direction of the rolling bearing.

The assembly groove located in the axial end face of the ring may include a positioning feature for positioning the wireless sensor in a circumferential direction and the radial direction of the rolling bearing.

The assembly groove located in the circumferential face of the ring may include a positioning feature for positioning the wireless sensor in the circumferential direction and the axial direction of the rolling bearing.

The ring may include an outer ring, and an outer circumferential face of the outer ring facing away from a rolling element of the rolling bearing may be provided with the assembly groove.

The ring may include an inner ring, and an axial end face of the inner ring may be provided with the assembly groove.

Groove side walls of the assembly groove and recesses arranged on the groove side walls may form the positioning feature, and/or the groove side walls of the assembly groove and a step arranged on a groove bottom wall of the assembly groove may form the positioning feature.

The groove side walls of the assembly groove may form the positioning feature, and a width of the opening along the circumferential direction may be smaller than that of an axial inner portion or a radial intermediate portion of the assembly groove along the circumferential direction.

The rolling bearing assembly may further include a rotating shaft mounted with the inner ring, and the rotating shaft may position the wireless sensor in an axial direction of the inner ring.

The rolling bearing assembly may further include a bearing seat mounted with the outer ring, and the bearing seat may position the wireless sensor in a radial direction of the outer ring.

The wireless sensor may be bonded to the assembly groove.

The above-mentioned technical solution may at least achieve the following advantages:

The opening, which is open in the axial direction, of the assembly groove in the circumferential face of the ring and/or the opening, which is open in the radial direction, of the assembly groove in the end face of the ring serve/serves as a window for communication between the wireless sensor and the outside, such that the wireless sensor is mounted in the assembly groove and also communicates well with the outside. Accordingly, the wireless sensor monitors, in real time, the ring of the rolling bearing, and the part of the rolling bearing for mounting the wireless sensor has a simple structure and is easily machined.

### BRIEF DESCRIPTION OF THE DRAWINGS

FIG. 1 is an exploded view of one exemplary embodiment of a rolling bearing assembly capable of realizing self-monitoring provided by the present disclosure.

FIG. 2 is a schematic view of a first embodiment of an assembly groove of an outer ring of a rolling bearing assembly capable of realizing self-monitoring.

FIG. 3 is a schematic view of a second embodiment of an assembly groove of an outer ring of a rolling bearing assembly capable of realizing self-monitoring.

FIG. 4 is a schematic view of a third embodiment of an assembly groove of an outer ring of a rolling bearing assembly capable of realizing self-monitoring.

FIG. 5 is a schematic view of a first embodiment of an assembly groove of an inner ring of a rolling bearing assembly capable of realizing self-monitoring.

FIG. 6 is a schematic view of a second embodiment of an assembly groove of an inner ring of a rolling bearing assembly capable of realizing self-monitoring.

FIG. 7 is a schematic view of a third embodiment of an assembly groove of an inner ring of a rolling bearing assembly capable of realizing self-monitoring.

FIG. 8 is a schematic view of one exemplary embodiment of a wireless sensor.

### DETAILED DESCRIPTION

Exemplary embodiments of the present invention will be described below with reference to the attached drawings.

As shown in FIG. 1, the present disclosure provides a rolling bearing assembly capable of realizing self-monitoring, wherein the rolling bearing assembly includes a rolling bearing 1, the rolling bearing 1 includes a ring and a rolling element 4, and the ring includes a fixed ring 2 and a rotating ring 3. For example, in the illustrated embodiment, the fixed ring 2 is an outer ring, and the rotating ring 3 is an inner ring.

In other embodiments not illustrated, the fixed ring 2 may be an inner ring, and the rotating ring 3 may be an outer ring.

The rolling bearing 1 further includes a wireless sensor 7, and the wireless sensor 7 is mounted to, for example, bonded to, the fixed ring 2 and the rotating ring 3 of the rolling bearing 1. The wireless sensor 7 can monitor the rotating ring 3 and the fixed ring 2 in real time. The wireless sensor 7 can rotate with the rotating ring 3 while monitoring the rotating ring 3 without external wires.

The rolling bearing assembly may include, for example, three wireless sensors 7, with two wireless sensors 7 arranged on the fixed ring 2 and one wireless sensor 7 arranged on the rotating ring 3. The number and positions of the wireless sensors 7 may be determined in consideration of avoiding a bearing area of the bearing, facilitating bearing mounting, enhancing signal strength, reducing machining cost and improving feasibility, and according to monitoring needs.

Multiple wireless sensors 7 may be arranged at different positions of the same ring, thereby realizing online monitoring of different positions.

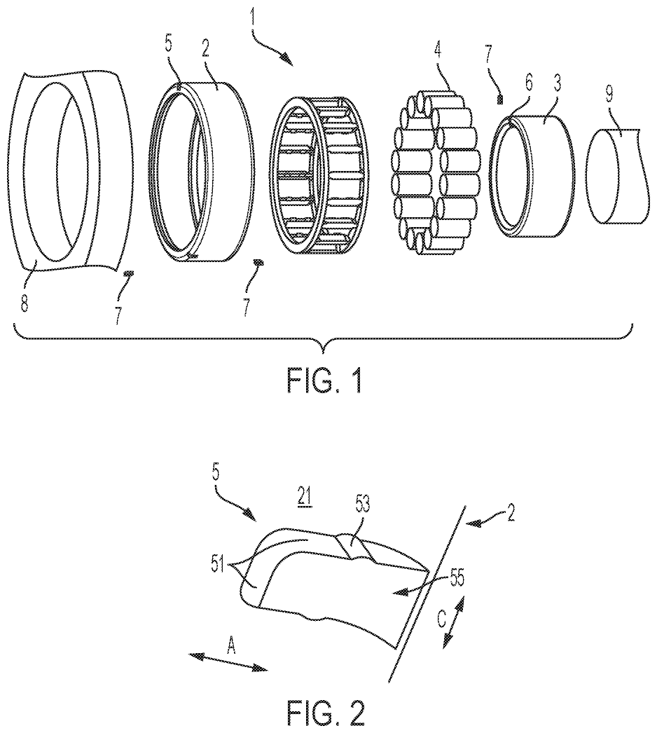

As shown in FIG. 2 to FIG. 7, the rolling bearing 1 has an assembly groove 5, 6 for mounting the wireless sensor 7, wherein the assembly groove 5 is arranged in the fixed ring 2, and the assembly groove 6 is arranged in the rotating ring 3. The assembly groove 5, 6 is arranged such that the wireless sensor 7 does not exceed an axial boundary and a radial boundary of the rolling bearing 1 when mounted to the assembly groove 5, 6, and thus, the wireless sensor 7 substantially does not affect the mounting of the rolling bearing 1.

The assembly groove 5 is, for example, located in an outer circumferential face 21 of the fixed ring 2 facing away from the rolling element 4, for example, an outer circumferential face of the outer ring, and the wireless sensor 7 can be mounted to the assembly groove 5 along a radial direction R. Here, the assembly groove 5 may be referred to as an assembly groove on the circumferential face of the ring.

The assembly groove 5 may be located in an axial edge of the outer circumferential face 21 of the fixed ring 2, and the assembly groove 5 has an opening 55 that is open in an axial direction A of the rolling bearing 1 at the axial edge of the outer circumferential face 21 of the fixed ring 2. Through the opening 55, the wireless sensor 7 communicates with an external device.

In other embodiments, the position of the assembly groove 5 may be changed.

For example, the assembly groove 5 may be located in a half of the outer circumferential face 21 of the fixed ring 2 in the axial direction A or the like, as long as the assembly groove 5 has the opening 55 that is open in the axial direction A.

The opening 55, which is open in the axial direction, of the assembly groove 5 serves as a window for communication between the wireless sensor 7 and the outside, such that the wireless sensor 7 is mounted in the assembly groove 5 and also communicates with the outside. Accordingly, the wireless sensor 7 monitors, in real time, the fixed ring 2 of the rolling bearing 1, and the part of the rolling bearing 1 for mounting the wireless sensor 7 has a simple structure and is easily machined.

The assembly groove 5 has a positioning feature that can position the wireless sensor 7 in the axial direction A and a circumferential direction C of the rolling bearing 1, thereby enhancing the positioning of the wireless sensor 7, for example, realizing double insurance of the positioning of the wireless sensor 7 on the basis that the wireless sensor 7 is bonded to the rolling bearing 1.

Specifically, as shown in FIG. 2, in the first embodiment, the positioning feature may be formed by groove side walls 51 of the assembly groove 5 and recesses 53 arranged on the groove side walls 51. The groove side walls 51 are used for positioning the wireless sensor 7 in the circumferential direction C of the rolling bearing 1, and the recesses 53 are used for positioning the wireless sensor 7 in the axial direction A of the rolling bearing 1. The recesses 53 have, for example, inner surfaces with smooth transitions. The recesses 53 are, for example, arranged on two opposite groove side walls 51 of the assembly groove 5.

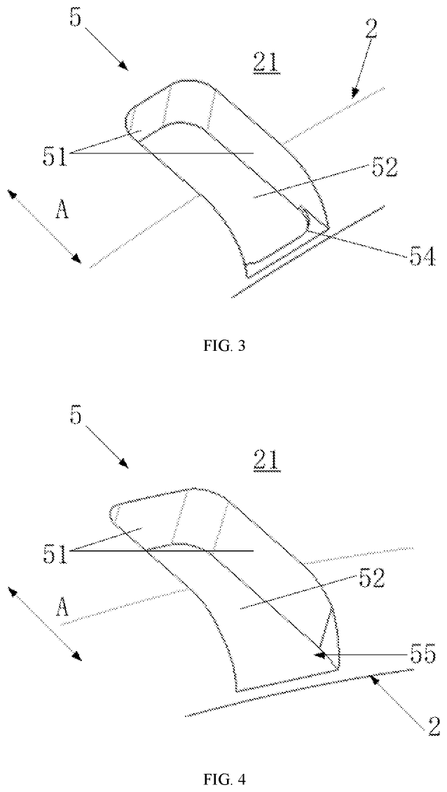

As shown in FIG. 3, in the second embodiment, the positioning feature may be formed by the groove side walls 51 of the assembly groove 5 and a step 54 arranged on a groove bottom wall 52 of the assembly groove 5. The step 54 may be located at an axial outer end (the end of the assembly groove 5 away from an axial center of the ring in the axial direction A) of the assembly groove 5, an axial inner end (the end of the assembly groove 5 near the axial center of the ring in the axial direction A) of the assembly groove 5 is provided with the groove side walls 51, and the groove side walls 51 and the step 54 together position the wireless sensor 7 in the axial direction A of the rolling bearing 1.

As shown in FIG. 4, in the third embodiment, the positioning feature may be formed by the groove side walls 51 of the assembly groove 5, and a width of the opening 55 of the groove side walls 51 along the circumferential direction C may be smaller than that of an axial inner portion of the assembly groove 5 along the circumferential direction C, and thus the assembly groove 5 has an opening closing shape. The opening 55 may be located at the axial outer end of the assembly groove 5, the axial inner end of the assembly groove 5 is provided with the groove side walls 51, and the groove side walls 51 and the opening 55 together position the wireless sensor 7 in the axial direction A of the rolling bearing 1.

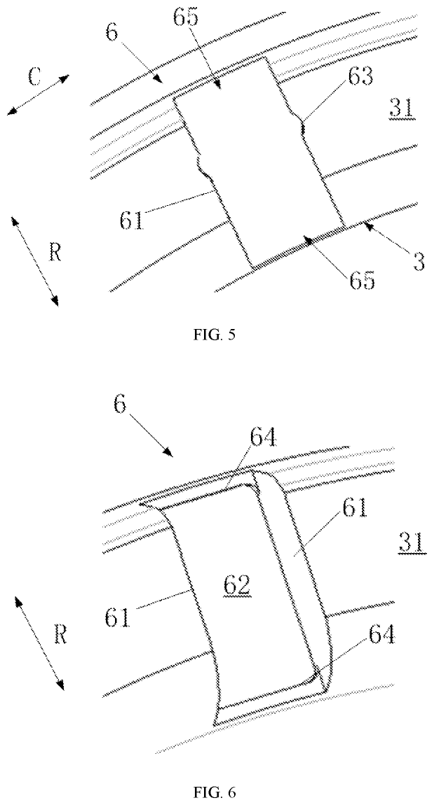

As shown in FIG. 5 to FIG. 7, the rolling bearing 1 comprises an assembly groove 6 located in the rotating ring 3, the assembly groove 6 is located in an end face 31 of the rotating ring 3, for example, the end face 31 of the inner ring, and the wireless sensor 7 may be mounted to the assembly groove 6 along the axial direction A. Here, the assembly groove 6 may be referred to as an assembly groove on the end face of the ring.

The assembly groove 6 may extend from a radial inner side to a radial outer side of the end face 31 of the rotating ring 3, and the assembly groove 6 has an opening 65 that is open in a radial direction R of the rolling bearing 1 at a radial edge of the end face 31 of the rotating ring 3. The wireless sensor 7 may communicate with the external device through the opening 65 that is open outward in the radial direction R.

In addition, the wireless sensor 7 may also communicate with the outside through a portion of the assembly groove 6 that is not blocked by, for example, a shoulder of a rotating shaft 9, in the axial direction A.

It should be understood that the side of the rotating ring 3 away from the rotating shaft 9 has the rolling element 4, the rolling element 4 is generally shorter in the axial direction than the rotating ring 3, and the radial edge of the rotating ring 3 generally has a chamfer, such that the assembly groove 6 arranged in the end face 31 of the rotating ring 3 has the opening 65 that is open outward in the radial direction.

The opening 65 on the side of the rotating ring 3 away from the rotating shaft 9 is open, while the opening 65 on the side near the rotating shaft 9 is generally blocked by the rotating shaft 9 from being in an open state. For example, when the inner ring is used as the rotating ring 3, the opening 65 at a radial inner edge is normally blocked by the rotating shaft 9 from being in the open state, and the opening 65 at a radial outer edge is in the open state.

In other embodiments, the position of the assembly groove 6 may be changed, for example, the assembly groove 6 may be located at a half of the radial inner side or a half of the radial outer side of the end face 31 of the rotating ring 3, as long as the assembly groove 6 has the opening 65 that is open in the radial direction R.

The opening 65, which is open in the radial direction R, of the assembly groove 6 serves as a window for communication between the wireless sensor 7 and the outside, such that the wireless sensor 7 is mounted in the assembly groove 6 and also communicates with the outside. Accordingly, the wireless sensor 7 monitors, in real time, the rotating ring 3 of the rolling bearing 1, and the part of the rolling bearing 1 for mounting the wireless sensor 7 has a simple structure and is easily machined.

The positioning feature of the assembly groove 6 of the rotating ring 3 is similar to that of the assembly groove 5 of the fixed ring 2 described above, and the difference between the two will be described below.

As shown in FIG. 5, in the first embodiment, the positioning feature is formed by groove side walls 61 and recesses 63 arranged on the groove side walls 61. The groove side walls 61 are used for positioning the wireless sensor 7 in the circumferential direction C of the rolling bearing 1, and the recesses 63 are used for positioning the wireless sensor 7 in the radial direction R of the rolling bearing 1. The recesses 63 have, for example, inner surfaces with smooth transitions. The recesses 63 are, for example, arranged on two opposite groove side walls 61 of the assembly groove 6.

As shown in FIG. 6, in the second embodiment, the positioning feature may be formed by the groove side walls 61 and a step 64 arranged on a groove bottom wall 62 of the assembly groove 6. The step 64 may be, for example, located at both radial ends of the assembly groove 6, thereby being used for positioning the wireless sensor 7 in the radial direction R of the rolling bearing 1.

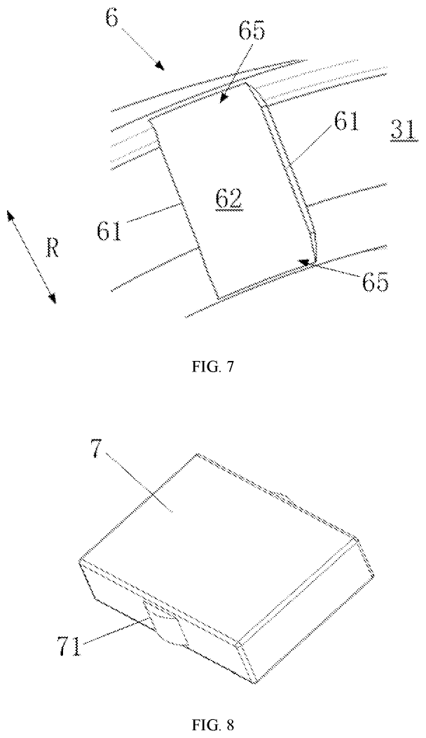

As shown in FIG. 7, in the third embodiment, the positioning feature may be formed by the groove side walls 61 of the assembly groove 6, a width of the opening 65 of the groove side walls 61 along the circumferential direction C may be smaller than that of a radial intermediate portion of the assembly groove 6 along the circumferential direction C, and thus the assembly groove 6 has an opening closing shape. The assembly groove 6 may have two openings 65, and the two openings 65 are located at both radial ends of the assembly groove 6, such that the groove side walls 61 position the wireless sensor 7 in the radial direction R of the rolling bearing 1 at the two openings 65.

As shown in FIG. 8, the wireless sensor 7 mounted with the assembly groove 5, 6 having the recesses 53, 63 has lugs 71, and the lugs 71 are assembled with the recesses 53, 63. The wireless sensor 7 mounted with the assembly groove 5, 6 having the step 54, 64 or the opening closing shape may not have the above-mentioned lugs 71.

Of course, the features of the multiple embodiments described above may be properly combined.

The rolling bearing assembly may further include a bearing seat 8 mounted with the fixed ring 2 and a rotating shaft 9 mounted with the rotating ring 3. The bearing seat 8 is located at a radial outer side of the wireless sensor 7, thereby positioning the wireless sensor 7 in the radial direction R of the fixed ring 2. The rotating shaft 9, for example, a shoulder of the rotating shaft 9, positions the wireless sensor 7 in the axial direction A of the rotating ring 3.

The bearing seat 8 and the rotating shaft 9 can also enhance the positioning of the wireless sensor 7 on the basis that the wireless sensor 7 is bonded to the rolling bearing 1, thereby realizing double insurance of the positioning of the wireless sensor 7.

The above-mentioned wireless sensor 7 comprises, for example, a temperature sensor.

Naturally, the present disclosure is not limited to the above-mentioned embodiments, and a person skilled in the art could make various modifications to the above-mentioned embodiments of the present disclosure guided by the present disclosure without departing from the scope of the present disclosure.

### LIST OF REFERENCE NUMERALS

1 Rolling bearing,
2 fixed ring,
21 outer circumferential face,
3 rotating ring,
31 end face,
4 rolling element,
5, 6 assembly groove,
51, 61 groove side wall,
52, 62 groove bottom wall,
53, 63 recess,
54, 64 step,
55, 65 opening,
7 wireless sensor,
71 lug,
8 bearing seat,
9 shaft.

1. A rolling bearing assembly, comprising:
a rolling bearing including a ring having an assembly groove and a wireless sensor mounted in the assembly groove,
wherein the assembly groove is located in a circumferential face of the ring and has an opening that is open in an axial direction of the rolling bearing.

2. The rolling bearing assembly according to claim 1, wherein the further assembly groove includes a positioning feature for positioning the further wireless sensor in a circumferential direction and the radial direction of the rolling bearing.

3. The rolling bearing assembly according to claim 1, wherein the assembly groove includes a positioning feature for positioning the wireless sensor in the circumferential direction and the axial direction of the rolling bearing.

4. The rolling bearing assembly according to claim 1, wherein the rolling bearing includes a rolling element, and the ring includes an outer ring, the assembly groove being provided on an outer circumferential face of the outer ring facing away from the rolling element.

5. The rolling bearing assembly according to claim 11, wherein the ring includes an inner ring, the further assembly groove being provided on an axial end face of the inner ring.

6. The rolling bearing assembly according to claim 3, wherein the positioning feature is formed by groove side walls of the assembly groove and at least one of recesses arranged on the groove side walls or a step arranged on a groove bottom wall of the assembly groove.

7. The rolling bearing assembly according to claim 3, wherein the positioning feature is formed by groove side walls of the assembly groove, and a width of the opening along the circumferential direction is smaller than that of an axial inner portion of the assembly groove along the circumferential direction.

8. The rolling bearing assembly according to claim 5, wherein the rolling bearing assembly includes a rotating shaft mounted with the inner ring and configured to position the wireless sensor in an axial direction of the inner ring.

9. The rolling bearing assembly according to claim 4, wherein the rolling bearing assembly includes a bearing seat mounted with the outer ring and configured to position the wireless sensor in a radial direction of the outer ring.

10. The rolling bearing assembly according to claim 1, wherein the wireless sensor is bonded to the assembly groove.

11. The rolling bearing assembly according to claim 1, wherein the ring includes a further assembly groove and a further wireless sensor mounted in the further assembly groove, the further assembly groove being located in an axial end face of the ring and having a further opening that is open in a radial direction of the rolling bearing.

12. The rolling bearing assembly according to claim 2, wherein the positioning feature is formed by groove side walls of the further assembly groove and at least one of recesses arranged on the groove side walls or a step arranged on a groove bottom wall of the assembly groove.

13. The rolling bearing assembly according to claim 2, wherein the positioning feature is formed by groove side walls of the further assembly groove, and a width of the further opening along the circumferential direction is smaller than that of a radial intermediate portion of the further assembly groove along the circumferential direction.

14. The rolling bearing assembly according to claim 11, wherein the ring includes an outer ring and an inner ring arranged concentrically with each other, the assembly groove being provided on the outer ring, and the further assembly groove being provided on the inner ring.

15. A rolling bearing assembly, comprising:
a rolling bearing including a ring having an assembly groove and a wireless sensor mounted in the assembly groove,
wherein the assembly groove is in an axial end face of the ring and has an opening that is open in a radial direction of the rolling bearing.

16. The rolling bearing assembly according to claim 15, wherein the assembly groove includes a positioning feature for positioning the wireless sensor in a circumferential direction and the radial direction of the rolling bearing.

17. The rolling bearing assembly according to claim 16, wherein the positioning feature is formed by groove side walls of the further assembly groove and at least one of recesses arranged on the groove side walls or a step arranged on a groove bottom wall of the assembly groove.

18. The rolling bearing assembly according to claim 16, wherein the positioning feature is formed by groove side walls of the further assembly groove, and a width of the further opening along the circumferential direction is smaller than that of a radial intermediate portion of the further assembly groove along the circumferential direction.

19. The rolling bearing assembly according to claim 15, wherein the ring includes an inner ring, the further assembly groove being provided on an axial end face of the inner ring.

20. The rolling bearing assembly according to claim 19, wherein the rolling bearing assembly includes a rotating shaft mounted with the inner ring and configured to position the wireless sensor in an axial direction of the inner ring.
